(19) United States
(12) Patent Application Publication
(10) Pub. No.: US 2014/0160031 A1
(43) Pub. Date: Jun. 12, 2014

(54) QUADRATIC CONVERTER MINIMIZING DRIVER SIZE FOR PIEZO HAPTICS

(71) Applicant: David Schie, San Jose, CA (US)

(72) Inventor: David Schie, San Jose, CA (US)

(21) Appl. No.: 13/706,564

(22) Filed: Dec. 6, 2012

(51) Int. Cl. G06F 3/01; G05F 1/618

(52) U.S. Cl. CPC G06F 3/016; G05F 1/618
USPC 345/173; 323/311

(57) ABSTRACT

A converter and switch mode power supply providing a high voltage signal. Generally described, the converter reduces the driver size required to generate high voltages. A controller which continuously operates the quadratic converter can reduce hard switch losses, electromagnetic interference, and component stress. The controller can utilize soft switching which improves efficiency, eliminates the need for snubbers, and reduces rating requirements. In one illustrative embodiment, the converter can include dual inductors with a single switch architecture. The switch can allow electric energy to be charged within each of the inductors during an “on” state of the switch, while said electric energy can be discharged delivering the same during an “off” state of the switch. A pulse train signal can be fed into the switch so that the converter provides a peak voltage much greater than the voltage placed into the converter.

### TECHNICAL FIELD

This application generally relates to electronic devices, and, more particularly, to a power converter for driving piezo haptic devices within portable electronics while eliminating the use of snubbers, reducing electromagnetic interference, and minimizing stress on components.

### BACKGROUND

Today, cellular telephones, personal digital assistants (PDAs), portable gaming devices, and a variety of other portable electronic devices have become commonplace. Manufacturers have produced rich interfaces for users. Conventional devices use visual and auditory cues to provide feedback to a user. In some interface devices, kinesthetic feedback (such as active and resistive force feedback) and/or tactile feedback (such as vibration, texture, and heat) is provided to the user, more generally known collectively as “haptic feedback.” Haptic feedback can provide cues that enhance and simplify the user interface. Vibration effects, or vibro-tactile haptic effects, may be useful in providing cues to users of electronic devices to alert the user to specific events, or provide realistic feedback to create greater sensory immersion within a simulated or virtual environment.

Some portable gaming applications are capable of vibrating in a manner similar to control devices (e.g., joysticks, etc.) used with larger-scale gaming systems that are configured to provide haptic feedback. Additionally, devices such as cellular telephones and PDAs are capable of providing various alerts to users by way of vibrations. For example, a cellular telephone can alert a user to an incoming telephone call by vibrating. Similarly, a PDA can alert a user to a scheduled calendar item or provide a user with a reminder for a “to do” list item or calendar appointment.

Increasingly, portable devices are moving away from physical buttons in favor of touch screen only interfaces. This shift allows increased flexibility, reduced parts count, and reduced dependence on failure-prone mechanical buttons and is in line with emerging trends in product design. When using the touch screen input device, a mechanical confirmation or other user interface action can be simulated with haptics.

Often haptic effects require a substantial amount of power. Due to this power constraint, the development of new devices has been stifled. Based on the foregoing, there is a need for an improved system and method for driving piezo haptic devices within portable electronics while minimizing the driver size. Furthermore, there is a need to eliminate the use of snubbers, reduce electromagnetic interference, and minimize the stress on components.

### SUMMARY

This summary is provided to introduce a selection of concepts in a simplified foam that are further described below in the DESCRIPTION OF THE APPLICATION. This summary is not intended to identify key features of the claimed subject matter, nor is it intended to be used as an aid in determining the scope of the claimed subject matter.

In accordance with one aspect of the present application, a converter is presented. The converter includes a switching element connected to a plurality of boost converter units in series operation. In addition, the converter includes a control circuit for switching of said switching element structured so that electric energy can be charged within each of the boost converter units during turning-on of said switching element, while said electric energy can be discharged delivering the same during turning-off said switching element.

In accordance with another aspect of the present application, a portable electronic device is presented. The device includes a touch screen and piezoelectric elements for simulating buttons on said touch screen. In addition, the device includes a switch mode power supply for driving said piezoelectric elements within said portable electronic device. The switch mode power supply includes a first inductor and a diode and capacitor connected to said first inductor, said first inductor receiving an input voltage. In addition, the switch mode power supply includes a second inductor and a diode connected to said second inductor, wherein said second inductor is coupled to said diode and said capacitor connected to said first inductor, said piezoelectric element connected to said diode connected to said second inductor. Furthermore the switch mode power supply includes a switch element coupled to said first inductor and said second inductor resulting in input voltage being less than a peak voltage of said piezoelectric element.

In accordance with yet another aspect of the present application, a switch mode power supply having an input terminal, an output terminal and a ground reference terminal is presented. The switch mode power supply includes a first inductor having a first terminal and a second terminal, said first terminal of said first inductor coupled to said input terminal. In addition, the switch mode power supply includes a first diode having an anode and a cathode, said anode of said first diode coupled to said second terminal of said inductor. The switch mode power supply includes an interim capacitor having a first terminal and a second terminal, said first terminal of said interim capacitor coupled to said cathode of said first diode, said second terminal of said interim capacitor coupled to said ground reference terminal. Furthermore, the switch mode power supply includes a second inductor having a first terminal and a second terminal, said first terminal coupled to said cathode of said first diode and said first terminal of said interim capacitor. The switch mode power supply includes a second diode having an anode and a cathode, said anode of said second diode coupled to said second terminal of said second inductor, said cathode of said second diode coupled to said output terminal. The switch mode power supply includes a third diode having an anode and a cathode, said anode of said third diode coupled to said second terminal of said first inductor and said anode of said first diode, said cathode of said third diode coupled to said second terminal of said second inductor and said anode of said second diode. The switch mode power supply includes a switch having a first terminal and a second terminal, said first terminal coupled to said second terminal of said second inductor, said cathode of said third diode, and said anode of said second diode, said second terminal of said switch coupled to said ground reference terminal.

### BRIEF DESCRIPTION OF DRAWINGS

The novel features believed to be characteristic of the application are set forth in the appended claims. In the descriptions that follow, like parts are marked throughout the specification and drawings with the same numerals, respectively. The drawing figures are not necessarily drawn to scale and certain figures may be shown in exaggerated or generalized in the interest of clarity and conciseness. The application itself, however, as well as a preferred mode of use, further objectives and advantages thereof, will be best understood by reference to the following detailed description of illustrative embodiments when read in conjunction with the accompanying drawings, wherein:

FIG. 1 is an illustrative top plan view of a typical portable device having a touch screen in accordance with one aspect of the present application;

FIG. 2 defines a cross-sectional view of the exemplary portable device as described in FIG. 1 in accordance with one aspect of the present application;

FIG. 3 shows a high-level block diagram of a typical quadratic boost converter that can provide a continuous conversion ratio to piezo haptics in accordance with one aspect of the present application;

FIG. 4 provides a circuit diagram of a typical quadratic boost converter in accordance with one aspect of the present application;

FIG. 5 illustrates an exemplary pulse train control signal fed into a switch that is used within the typical quadratic boost converter in accordance with one aspect of the present application;

FIG. 6 shows the exemplary switch within the typical quadratic boost converter in an “On-State” in accordance with one aspect of the present application;

FIG. 7 shows the exemplary switch within the typical quadratic boost converter in an “Off-State” in accordance with one aspect of the present application;

FIG. 8 is a flow chart illustrating exemplary processes when the quadratic boost converter is in an “On-State” in accordance with one aspect of the present application; and

FIG. 9 is a flow chart illustrating exemplary processes when the quadratic boost converter is in an “Off-State” in accordance with one aspect of the

### DESCRIPTION OF THE APPLICATION

The description set forth below in connection with the appended drawings is intended as a description of presently-preferred embodiments of the application and is not intended to represent the only forms in which the present application may be constructed and/or utilized. The description sets forth the functions and the sequence of steps for constructing and operating the application in connection with the illustrated embodiments. It is to be understood, however, that the same or equivalent functions and sequences may be accomplished by different embodiments that are also intended to be encompassed within the spirit and scope of this application.

Generally described, the present application relates to a switch mode power supply, and more particularly, to a converter for reducing the driver size required to generate high voltages. In one illustrative embodiment, the converter can include converter units in series operation. A piezoelectric element can be coupled to the last converter unit. The converter can also include a switching element coupled to the converter units wherein the switching element allows the converter units to produce a peak voltage for the piezoelectric element much greater than the input voltage placed into the converter.

Typically, the converter includes dual inductors with a single switch architecture. When dual inductors are used, a quadratic converter can be formed. The converter can drive piezo haptics allowing much smaller solutions than presently available. In some embodiments, which are described in further details below, a controller which continuously operates the quadratic converter can reduce hard switch losses, electromagnetic interference, and component stress. Furthermore, the controller can utilize soft switching which improves efficiency, eliminates the need for snubbers, and reduces rating requirements.

The present application is not limited to quadratic converters, but can also encompass other circuits having converter units in series using a switching element. One skilled in the relevant art can appreciate that the output terminal of the converter can drive many devices that require high voltages. One such output terminal can include piezoelectric elements within a portable device.

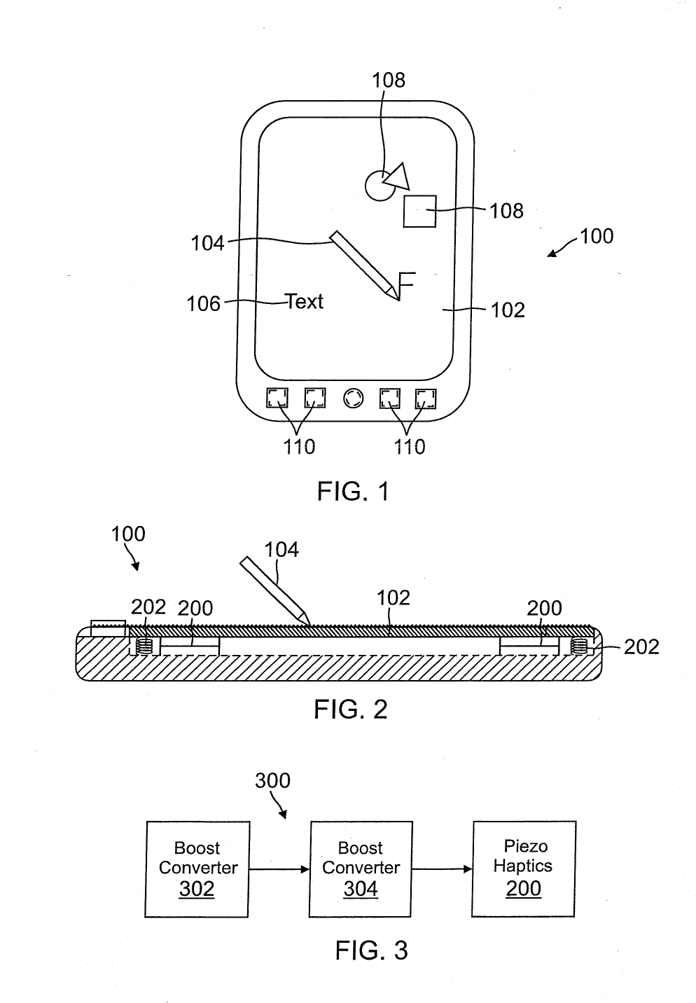

Portable devices can include cellular telephones, PDAs, portable gaming devices, and a variety of other portable electronic devices. As shown in FIG. 1, a portable device can include a haptic touchpad 102 along with a pen 104. Typically, the touchpad 102 can cover a large portion of the surface of the portable device 100. The touchpad 102 can display text 106, images 108, animations, etc.

The touchpad 102 can include sensors that allow a user to input information to the portable device 100. Generally, input is provided into the portable device 100 by physical contact with the touchpad 102. When pressure is detected, the portable device 100 determines the desired input from the user.

Physical buttons 110 can also be included in the housing of the device 100 to provide particular commands to the device 100 when the buttons 110 are pressed. Many PDA's are characterized by the lack of a standard keyboard for character input from the user; rather, an alternative input mode is used, such as using a pen 104 to draw characters on the touchpad 102, voice recognition, etc. Some PDA's can include a fully-functional keyboard as well as a touchpad 102, where the keyboard is typically much smaller than a standard-sized keyboard.

The touchpad 100 can provide haptic feedback to the user. One or more actuators 200 can be coupled to the underside of the touchpad 102 to provide haptic feedback such as pulses, vibrations, and textures. For example, an actuator 200 can be positioned near each corner of the touchpad 102, as shown in FIG. 2. Other configurations of actuators 200 can also be used. The user can experience the haptic feedback through a finger or a held object such as a pen 104 that is contacting the touchpad 102.

As further shown in FIG. 2, the portable device 100 can include one or more spring or compliant elements 202, such as helical springs, leaf springs, flexures, or compliant material (foam, rubber, etc.). The compliant element allows the touchpad 102 to move approximately along the z-axis, thereby providing haptic feedback similarly to the touchpad embodiments described above. Actuators 200 can be piezo-electric actuators.

The components described above should not be construed as limiting to those within a portable device 100. Those skilled in the relevant art can appreciate that the portable device 100 can include other elements such as receivers, batteries, antennas, etc. Furthermore, the present application should not be limited to portable devices, but may also include other electronics using high voltages.

To drive piezoelectric actuators or elements 200 within electronics, a converter 300 for providing a high voltage signal, as shown in FIG. 3, can be used. FIG. 3 shows a high-level block diagram of a typical converter 300 that can provide a continuous conversion ratio to piezo haptics 200 in accordance with one aspect of the present application. Generally described, the converter 300 can incorporate two boost converter units 302 and 304 to form a quadratic converter 300. In accordance with the present application, the boost converter units 302 and 304 are typically in series.

Although two boost converter units 302 and 304 have been shown within FIG. 3 to drive the piezo haptic device 200, additional boost converter units may be applied in series and fed into the piezo haptic device 200. While general features have been provided, more details regarding the boost converter 300 are now shown below.

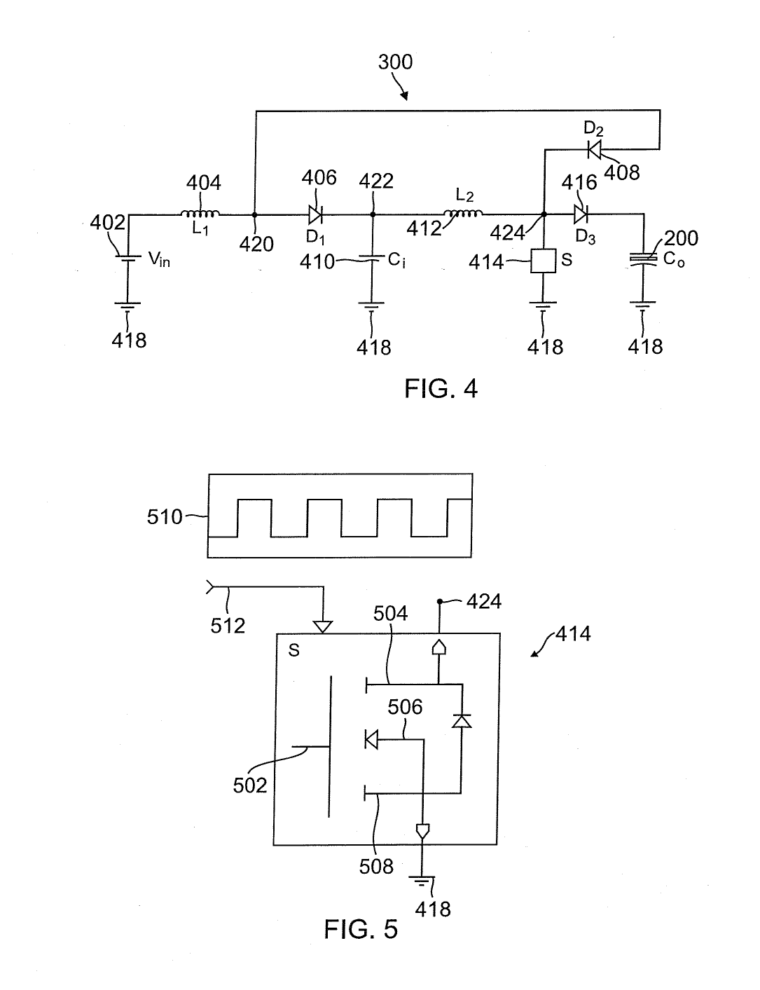

With reference to FIG. 4, a quadratic boost converter 300 circuit in accordance with one aspect of the present application is presented. As shown, the quadratic boost converter 300 can include an inductor L₁ 404, a diode D₁ 406, a diode D₂ 408, a single capacitance interim storage element Cᵢ 410, an inductor L₂ 412, a switching element S 414, and a diode D₃ 416 configuration as shown. Typically, diode D₁ 406 can be a Shottky diode. The input and output ports of the quadratic boost converter 300 can respectively be an input voltage source Vᵢₙ 402 and a capacitor Cₒ representing a piezoelectric element 200. Input voltage source Vᵢₙ 402, interim capacitor Cᵢ 410, switching element S 414, and piezoelectric element Cₒ 200 can be coupled to a ground referencing terminal 418.

Inductor L₁ 404, anode of diode D₁ 406, and anode of diode D₂ 408 can share a common node 420. The cathode of diode D₁ 406, interim capacitor Cᵢ 410, and inductor L₂ 412 can share a common node 422. Inductor L₂ 412, cathode of diode D₂ 408, switch S 414, and anode of diode D₃ 416 can share a common node 424.

Before describing the operations of the quadratic boot converter 300, switch S 414 is now described in more detail. With reference to FIG. 5, the switch S 414 can take the form of, but is not necessarily limited to, the embodiment shown. The switch S 414 can be coupled to node 424 and ground reference terminal 418. The switch S 414 can act like a regulator or controller for the quadratic boost converter 300.

Switch S 414 can include logic circuitry for controlling the turning on and off of the converter units and can include delay circuitry for avoiding shoot through conditions. In one illustration, as shown in FIG. 5, the switch can include a single pole 502 and triple throws 504, 506, and 508. When switch S 414 is in an on state, the switch S 414 closes the single pole 502 to the triple throws 504, 506, and 508. When closed, the connection drives node 424 and those components associated with the node 424 to the ground reference terminal 418. In the alternative, when the switch S 414 is in an off state, the single pole 502 is not connected to the triple throws 504, 506, and 508 and the switch S 414 is open.

Coupled to pole 502 of switch S 414 is pulse train 510 fed through input 512. The pulse train control signal 410 can ensure that the current through inductor L₁ 404 reaches a zero magnitude each cycle. The pulse train control signal 510 can also ensure that the current through inductor L₁ 404 reverses each cycle. While a single pole 502 triple throw 504, 506, and 508 has been shown, one skilled in the relevant art can appreciate that a number of different switches may be used along with a variety of different pulse trains signals to obtain the desired effects provided in the present application.

Switch S 414 can provide a critical conduction mode controller which utilizes soft switching of the inductor L₁ 404 to improve efficiency, eliminate the need for snubbers and reduce component stress and therefore rating requirements. Furthermore, switch S 414 reduces EMI associated with hard switching of the higher current inductor L₁ 404 in continuous mode.

Throughout this application, the term converter 300 can be interchangeable with the terms boost converter, quadratic converter, switch mode power supply, or any derivative thereof. Inductors L₁ 404 and L₂ 412 can also be referred to as boost inductors. Diodes D₁ 406, D₂ 408, and D₃ 416 can be referred to as switching diodes. Switch S 414 can be referred to as a regulator or quadratic boost regulator. Capacitor Cᵢ 410 can be referred to as an interim capacitor. Capacitor Cₒ 200 can be referred to as an output capacitor or piezoelectric element.

As described below, quadratic converter 300 can provide a D/(1−D)̂2 continuous conversion ratio, wherein D is the duty cycle. D can represent the fraction of the commutation period T during which the switch is on. D can range between 0, where switch S 414 never on, and 1, where switch S 414 is always on. Due to its small component count, quadratic converter 300 provides a “best” topology for wide conversion ratio boosting. From the above expression it can be seen that the output voltage is generally higher than the input voltage, and that it increases with D. For example, an input voltage source Vᵢₙ 402 of 3V can be raised to greater than 100 V.

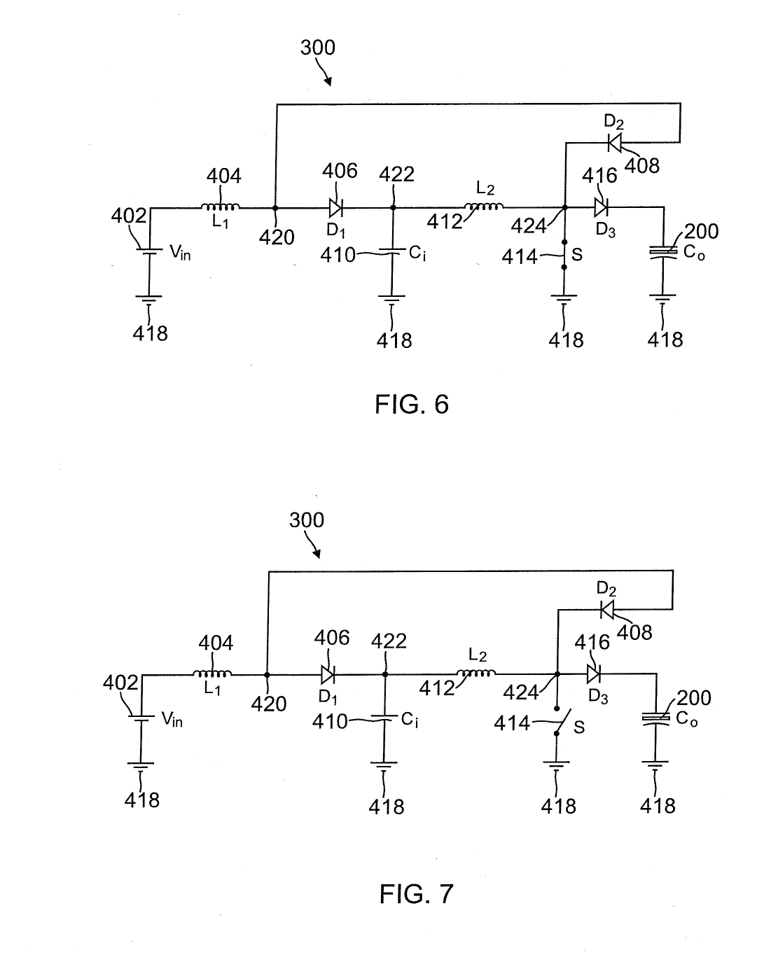

To illustrate operations and features of the converter 300, FIG. 6 shows the exemplary switch S 414 within the converter 300 in an on state in accordance with one aspect of the present application. Initially, each energy storage element has been discharged. In the on state, switch S 414 is closed. When closed, the voltage from Vᵢₙ 402 can go through inductor L₁ 404 and through diode D₂ 408 to the ground reference terminal 418. The input voltage Vᵢₙ 402 can appear across the inductor, which causes a change in current flowing through inductor L₁ 404. At the end of the on state, the current for inductor L₁ 404 increases which typically results in electrical energy being stored within inductor L₁ 404.

When the switch S 414 is in an off state, switch S 414 can be opened as shown in FIG. 7. The path offered to the inductor L₁ 404 can go through diode D₁ 406, capacitor Cᵢ 410, and inductor L₂ 412. Often this results in transferring energy accumulated during the on state from inductor L₁ 404 into capacitor Cᵢ 410. This ends the first cycle for switch S 414 whereby each energy storage element had initially been discharged.

Subsequent cycles, including an on and off state, for switch S 414 will now be described, the subsequent cycles generating the desired D/(1−D)̂2 continuous conversion ratio. When the switch S 414 goes into the on state again, as shown in FIG. 6, switch S 414 is closed. When closed, the voltage from Vᵢₙ 402 can go through inductor L₁ 404 and through diode D₂ 408 to the ground reference terminal 418. The input voltage, Vᵢₙ 402, again appears across the inductor, which causes the change in current flowing through inductor L₁ 404. At the end of the on state, the current for inductor L₁ 404 has increased resulting in electrical energy stored within inductor L₁ 404.

When switch S 414 is also closed, capacitor Cᵢ 410 can discharge its stored energy into inductor L₂ 412. As shown, and at the end of the on state in a subsequent cycle, electrical energy can be stored in both inductor L₁ 404 and inductor L₂ 412.

Completing the cycle, switch S 414 turns into its off state and the switch S 414 is opened again as shown in FIG. 7. The path offered to inductor L₁ 404 goes through diode D₁ 406, capacitor Cᵢ 410, and inductor L₂ 412. This time, however, inductor L₂ 412 already contains electrical energy providing additional voltage to any element connected to the output including the piezoelectric element Cₒ 200. Generally, the result is a D/(1−D)̂2 continuous conversion ratio.

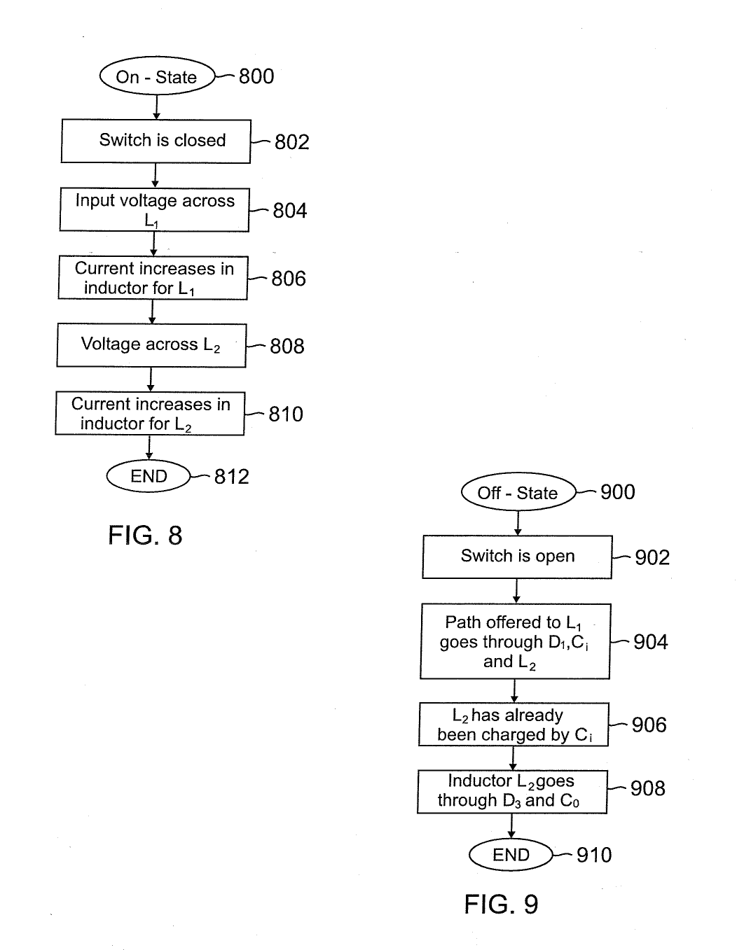

FIG. 8 is a flow chart illustrating exemplary processes for the quadratic boost converter 300 in an on state in accordance with one aspect of the present application. The flow chart illustrates a quadratic boost converter 300 that has cycled through an on and off state. The processes begin at block 800. At block 802, the switch is closed. At block 804, the input voltage from Vᵢₙ 402 can go through inductor L₁ 404 and through diode D₂ 408 to the ground reference terminal 418. The current for inductor L₁ 404 has increased resulting in electrical energy stored within inductor L₁ 404 at block 806.

At block 808, capacitor Cᵢ 410 can discharge its stored electrical energy into inductor L₂ 412. Current increases in inductor L₂ 412 at block 810. Electrical charge is stored in inductor Lᵢ 404 and inductor L₂ 412 at the end of the on state at block 812.

FIG. 9 is a flow chart illustrating exemplary processes for the quadratic boost converter 300 in an off state in accordance with one aspect of the present application. The flow chart illustrates a quadratic boost converter 300 that has cycled through an on and off state. The processes begin at block 900. At block 902, the switch is opened. At block 904, the path offered to inductor L₁ 404 goes through diode D₁ 406, capacitor Cᵢ 410, and inductor L₂ 412. Inductor L₂ 412 has already been charged by capacitor Cᵢ 410 at block 906. At block 908, inductor L₂ 412 goes through D₃ 416 and piezoelectric element Cₒ 200. The processes end at block 910.

One skilled in the relevant art will appreciate that the processes provided in both FIGS. 8 and 9 can continue as long as input voltage Vᵢₙ 402 is applied and a pulse signal 510 is applied to switch S 414. While exemplary components for quadratic converter 300 have been described, other elements and components may be included. For example, filters made of capacitor, sometimes in combination with inductors, are normally added to reduce output voltage ripple.

In accordance with one aspect of the present application, a converter is presented. The converter includes a switching element connected to a plurality of boost converter units in series operation. In addition, the converter includes a control circuit for switching of said switching element structured so that electric energy can be charged within each of the boost converter units during turning-on of said switching element, while said electric energy can be discharged delivering the same during turning-off said switching element.

In one embodiment, each booster converter unit within said plurality of boost converter units in series operation include at least an inductance and at least a rectifier connected to said inductance. In another embodiment, said plurality of boost converter units in series operation produce a quadratic converter. In another embodiment, said electrical energy discharged drives haptic piezo devices within portable electronics.

In accordance with another aspect of the present application, a portable electronic device is presented. The device includes a touch screen and piezoelectric elements for simulating buttons on said touch screen. In addition, the device includes a switch mode power supply for driving said piezoelectric elements within said portable electronic device. The switch mode power supply includes a first inductor and a diode and capacitor connected to said first inductor, said first inductor receiving an input voltage. In addition, the switch mode power supply includes a second inductor and a diode connected to said second inductor, wherein said second inductor is coupled to said diode and said capacitor connected to said first inductor, said piezoelectric element connected to said diode connected to said second inductor. Furthermore the switch mode power supply includes a switch element coupled to said first inductor and said second inductor resulting in input voltage being less than a peak voltage of said piezoelectric element.

In one embodiment, said switch element is a single controlled switch element. In another embodiment, said switch element includes an “on” state and “off” state, wherein energy is charged within said first inductor and said second inductor during said “on” state and said energy is discharged from said first inductor and said second inductor during said “off” state. In another embodiment, said switch element coupled to said first inductor and said second inductor is connected between said first inductor and said diode and capacitor connected to said first inductor and between said second inductor and said diode connected to said second inductor. In another embodiment, said input voltage is at least a factor of ten times smaller than a peak voltage of said piezoelectric element.

In another embodiment, said switch element is coupled to a pulse train control signal. In another embodiment, said pulse train control signal ensures that current through said first inductor reaches zero magnitude for each cycle within said pulse train control signal. In another embodiment, said pulse train control signal ensures that current through said first inductor reverses each cycle within said pulse train control signal. In another embodiment, said switch mode power supply further includes a diode coupled between said first inductor and said diode and capacitor connected to said first inductor and said switch element.

In accordance with yet another aspect of the present application, a switch mode power supply having an input terminal, an output terminal and a ground reference terminal is presented. The switch mode power supply includes a first inductor having a first terminal and a second terminal, said first terminal of said first inductor coupled to said input terminal. In addition, the switch mode power supply includes a first diode having an anode and a cathode, said anode of said first diode coupled to said second terminal of said inductor. The switch mode power supply includes an interim capacitor having a first terminal and a second terminal, said first terminal of said interim capacitor coupled to said cathode of said first diode, said second terminal of said interim capacitor coupled to said ground reference terminal. Furthermore, the switch mode power supply includes a second inductor having a first terminal and a second terminal, said first terminal coupled to said cathode of said first diode and said first terminal of said interim capacitor. The switch mode power supply includes a second diode having an anode and a cathode, said anode of said second diode coupled to said second terminal of said second inductor, said cathode of said second diode coupled to said output terminal. The switch mode power supply includes a third diode having an anode and a cathode, said anode of said third diode coupled to said second terminal of said first inductor and said anode of said first diode, said cathode of said third diode coupled to said second terminal of said second inductor and said anode of said second diode. The switch mode power supply includes a switch having a first terminal and a second terminal, said first terminal coupled to said second terminal of said second inductor, said cathode of said third diode, and said anode of said second diode, said second terminal of said switch coupled to said ground reference terminal.

In one embodiment, the switch mode power supply includes a piezoelectric actuator connected to said output terminal. In another embodiment, said connections between said first inductor, said first diode, and said third diode form a first node. In another embodiment, said connections between said first diode, said interim capacitor, and said second inductor form a second node. In another embodiment, said connections between said second inductor, said switch, said second diode, and said third diode form a third node. In another embodiment, said switch receives a pulse train signal. In another embodiment, said output terminal provides a high voltage signal that includes a continuous transfer function containing a second order term.

The foregoing description is provided to enable any person skilled in the relevant art to practice the various embodiments described herein. Various modifications to these embodiments will be readily apparent to those skilled in the relevant art, and generic principles defined herein may be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

What is claimed is:

1. A converter comprising:
a switching element connected to a plurality of boost converter units in series operation; and
a control circuit for switching of said switching element structured so that electric energy can be charged within each of the boost converter units during turning-on of said switching element, while said electric energy can be discharged delivering the same during turning-off said switching element.

2. The converter of claim 1, wherein each booster converter unit within said plurality of boost converter units in series operation comprise:
at least an inductance; and
at least a rectifier connected to said inductance.

3. The converter of claim 1, wherein said plurality of boost converter units in series operation produce a quadratic converter.

4. The converter of claim 1, wherein said electrical energy discharged drives haptic piezo devices within portable electronics.

5. A portable electronic device comprising:
a touch screen;
piezoelectric elements for simulating buttons on said touch screen; and
a switch mode power supply for driving said piezoelectric elements within said portable electronic device, said switch mode power supply comprising:
a first inductor and a diode and capacitor connected to said first inductor, said first inductor receiving an input voltage;
a second inductor and a diode connected to said second inductor, wherein said second inductor is coupled to said diode and said capacitor connected to said first inductor, said piezoelectric element connected to said diode connected to said second inductor; and
a switch element coupled to said first inductor and said second inductor resulting in input voltage being less than a peak voltage of said piezoelectric element.

6. The portable electronic device of claim 5, wherein said switch element is a single controlled switch element.

7. The portable electronic device of claim 5, wherein said switch element comprises an “on” state and “off” state, wherein energy is charged within said first inductor and said second inductor during said “on” state and said energy is discharged from said first inductor and said second inductor during said “off” state.

8. The portable electronic device of claim 5, wherein said switch element coupled to said first inductor and said second inductor is connected between said first inductor and said diode and capacitor connected to said first inductor and between said second inductor and said diode connected to said second inductor.

9. The portable electronic device of claim 5, wherein said input voltage is at least a factor of ten times smaller than a peak voltage of said piezoelectric element.

10. The portable electronic device of claim 5, wherein said switch element is coupled to a pulse train control signal.

11. The portable electronic device of claim 10, wherein said pulse train control signal ensures that current through said first inductor reaches zero magnitude for each cycle within said pulse train control signal.

12. The portable electronic device of claim 10, wherein said pulse train control signal ensures that current through said first inductor reverses each cycle within said pulse train control signal.

13. The portable electronic device of claim 5, wherein said switch mode power supply further comprises a diode coupled between said first inductor and said diode and capacitor connected to said first inductor and said switch element.

14. A switch mode power supply having an input terminal, an output terminal and a ground reference terminal, the switch mode power supply comprising:
a first inductor having a first terminal and a second terminal, said first terminal of said first inductor coupled to said input terminal;
a first diode having an anode and a cathode, said anode of said first diode coupled to said second terminal of said inductor;
an interim capacitor having a first terminal and a second terminal, said first terminal of said interim capacitor coupled to said cathode of said first diode, said second terminal of said interim capacitor coupled to said ground reference terminal;
a second inductor having a first terminal and a second terminal, said first terminal coupled to said cathode of said first diode and said first terminal of said interim capacitor;
a second diode having an anode and a cathode, said anode of said second diode coupled to said second terminal of said second inductor, said cathode of said second diode coupled to said output terminal;
a third diode having an anode and a cathode, said anode of said third diode coupled to said second terminal of said first inductor and said anode of said first diode, said cathode of said third diode coupled to said second terminal of said second inductor and said anode of said second diode; and
a switch having a first terminal and a second terminal, said first terminal coupled to said second terminal of said second inductor, said cathode of said third diode, and said anode of said second diode, said second terminal of said switch coupled to said ground reference terminal.

15. The switch mode power supply of claim 14, further comprising a piezoelectric actuator connected to said output terminal.

16. The switch mode power supply of claim 14, wherein said connections between said first inductor, said first diode, and said third diode form a first node.

17. The switch mode power supply of claim 16, wherein said connections between said first diode, said interim capacitor, and said second inductor form a second node.

18. The switch mode power supply of claim 17, wherein said connections between said second inductor, said switch, said second diode, and said third diode form a third node.

19. The switch mode power supply of claim 14, wherein said switch receives a pulse train signal.

20. The switch mode power supply of claim 14, wherein said output terminal provides a high voltage signal that includes a continuous transfer function containing a second order term.
